(19) United States
(12) Patent Application Publication
(10) Pub. No.: US 2025/0300816 A1
(43) Pub. Date: Sep. 25, 2025

(54) INFORMATION PROCESSING METHOD, SERVER DEVICE, AND INFORMATION PROCESSING DEVICE

(71) Applicant: SEIKO EPSON CORPORATION, Tokyo (JP)

(72) Inventor: Hiroyuki HASHIMOTO, HARA-MURA (JP)

(21) Appl. No.: 19/081,376

(22) Filed: Mar. 17, 2025

(30) Foreign Application Priority Data
Mar. 21, 2024 (JP) 2024-044842

(51) Int. Cl. H04L 9/08; H04L 9/32

(52) U.S. Cl. CPC H04L 9/0838; H04L 9/3228

(57) ABSTRACT

An information processing method according to an aspect of the present disclosure includes correlating device identification information indicating an output device to a first password by a server device that provides a service via a network, transmitting the first password to the output device by the server device, outputting information containing the first password by the output device, transmitting the first password to the server device by a first terminal device that has already logged in to the service using user identification information, correlating the user identification information to the device identification information based on the first password by the server device, transmitting a common key correlated to the user identification information to the first terminal device by the server device, displaying a second password based on the common key and an encryption algorithm by the first terminal device, receiving input of the second password by the output device, acquiring the user identification information corresponding to the common key from the server device based on the second password and the encryption algorithm by the output device, and executing processing based on the user identification information by the output device.

The present application is based on, and claims priority from JP Application Serial Number 2024-044842, filed Mar. 21, 2024, the disclosure of which is hereby incorporated by reference herein in its entirety.

### BACKGROUND

### 1. Technical Field

The present disclosure relates to an information processing method, a server device, and an information processing device.

### 2. Related Art

Various techniques have been proposed only for a user authenticated in advance to operate an image display device such as a projector, and examples thereof include the techniques disclosed in JP-A-2013-061881. A password generation device disclosed in JP-A-2013-061881 includes an operator authentication unit that authenticates an operator who operates an image display device, and a password generation unit that generates a disposable password for using the image display device for the authenticated operator. The image display device disclosed in JP-A-2013-061881 includes a password authentication unit that authenticates a disposable password input by an operation device for operating the image display device, and an operation controller that controls details of operations of the image display device according to an authentication result by the password authentication unit.

JP-A-2013-061881 is an example of the related art.

When an image display device is connected to a network and a terminal device such as a personal computer connected to the network is used as an operation device, in the method disclosed in JP-A-2013-061881, it is necessary to log the terminal device into a service, and then, further log the image display device into the service. There is a problem that a user spends time and effort therefor.

### SUMMARY

An information processing method according to an aspect of the present disclosure includes correlating device identification information indicating an output device to a first password by a server device that provides a service via a network, transmitting the first password to the output device by the server device, outputting information containing the first password by the output device, transmitting the first password to the server device by a first terminal device that has already logged in to the service using user identification information, correlating the user identification information to the device identification information based on the first password by the server device, transmitting a common key correlated to the user identification information to the first terminal device by the server device, displaying a second password based on the common key and an encryption algorithm by the first terminal device, receiving input of the second password by the output device, acquiring the user identification information corresponding to the common key from the server device based on the second password and the encryption algorithm by the output device, and executing processing based on the user identification information by the output device.

A server device according to an aspect of the present disclosure includes a communication device that communicates with each of an output device and a first terminal device, and at least one processor, wherein the at least one processor executes providing a service via a network, correlating device identification information indicating the output device to a first password, transmitting the first password to the output device using the communication device, receiving the first password using the communication device from the first terminal device that has already logged in to the service using user identification information, correlating the user identification information to the device identification information based on the first password, transmitting a common key associated with the user identification information to the first terminal device using the communication device to cause the first terminal device to output a second password based on the common key and a predetermined encryption algorithm, performing authentication of the second password based on the encryption algorithm, and transmitting the user identification information corresponding to the common key to the output device when the authentication is successful.

An information processing device according to an aspect of the present disclosure includes a communication device that communicates with each circuit board of a server device providing a service and an output device, and at least one processor, wherein the at least one processor executes transmitting device identification information indicating the output device to the server device using the communication device, acquiring a first password for correlating the device identification information to user identification information indicating a user that has logged in to the service from the server device, causing the output device to output information containing the first password, receiving a common key associated with the user identification information in the server device from the server device, receiving input of a second password based on the common key and an encryption algorithm, performing authentication of the second password based on the common key and the encryption algorithm, acquiring the user identification information corresponding to the common key from the server device when the authentication is successful, and causing the output device to execute processing based on the user identification information.

### BRIEF DESCRIPTION OF THE DRAWINGS

FIG. 1 shows a configuration example of an information system according to an embodiment of the present disclosure.

FIG. 2 shows a configuration example of a server device provided in the information system.

FIG. 3 shows an example of a management table stored in a storage device of the server device.

FIG. 4 shows an example of a UI screen output by an output device under control of an information processing device.

FIG. 5 shows a configuration example of the information processing device provided in the information system.

FIG. 6 shows a flow of processing in an information processing method executed in the information system.

FIG. 7 shows an example of a support screen according to another embodiment.

FIG. 8 shows an example of a UI screen of Modification Example (2).

### DESCRIPTION OF EMBODIMENTS

Various technically preferable limitations are imposed on the following embodiments. However, embodiments of the present disclosure are not limited to the following configurations.

### 1. Embodiments

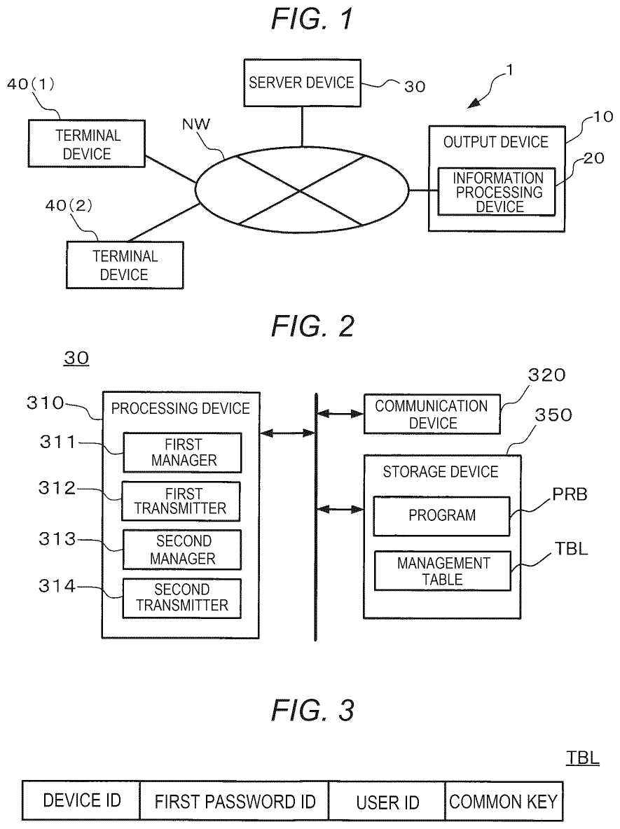

FIG. 1 shows a configuration example of an information system 1 that executes an information processing method according to one embodiment of the present disclosure. As shown in FIG. 1, the information system 1 includes an output device 10, a terminal device 40(1) and a terminal device 40(2), and a server device 30. The output device 10 includes an information processing device 20. Each of the information processing device 20, the terminal device 40(1), the terminal device 40(2), and the server device 30 is connected to a network NW such as the Internet. In the embodiment, in order to ensure security, communication compliant to HTTPS (HyperText Transfer Protocol Secure) is employed for communication between the terminal device 40 (1) or the terminal device 40(2) and the server device 30 and communication between the server device 30 and the information processing device 20. Specifically, the communication is realized by Web API (Web Application Programming Interface).

The information processing device 20 is a computer device that operates according to, for example, an Android OS (Operating System) and performs at least part of operation control of the output device 10 in response to an instruction given from the server device 30 via the network NW. In the embodiment, the information processing device 20 is disposed in a housing of the output device 10, however, the information processing device 20 may be a separate device from the output device 10 and wired-connected to the output device 10 from outside of the output device 10. When the information processing device 20 is externally connected to the output device 10, the information processing device 20 functions integrally with the output device 10, and thus can be regarded as a part of the output device 10.

The output device 10 is an image display device that displays an image, and specifically is a projector that displays an image on a projection target such as projection screen by projecting the image on the projection target. The output device 10 is installed, for example, in a classroom of a school, and projects an image such as a teaching material on a projection screen. In the output device 10, a device ID as identification information for uniquely identifying the output device 10 (for example, a character string representing a serial number or the like) is stored in advance. The device ID is an example of device identification information in the present disclosure.

Each of the terminal device 40(1) and the terminal device 40(2) is a smartphone used by a teacher or a student, and serves as an operation device for operating the output device 10 in the information system 1. Hereinafter, when it is not necessary to distinguish between the terminal device 40(1) and the terminal device 40(2), the terminal device 40(1) and the terminal device 40(2) are referred to as “terminal device 40”. Although not illustrated in detail in FIG. 1, the terminal device 40 includes a touch panel display for display and input of various types of information and a camera for capturing various types of images. Further, the terminal device 40 includes a web browser, and can access various websites using the web browser. Examples of the websites accessed by the terminal device 40 using the web browser include a portal site for logging in a service provided by the server device 30. Furthermore, the terminal device 40 has a web storage mechanism for storing data in the web browser while ensuring security. Although the two terminal devices 40 are illustrated in FIG. 1, the number of terminal devices 40 provided in the information system 1 may be one, three, or more. The terminal device 40 is an example of a first terminal device in the present disclosure.

The server device 30 is a device that provides a service (hereinafter, a shared service) for users of the terminal device 40(1) and the terminal device 40(2) to share the output device 10. The user of the terminal device 40 can share the output device 10 by accessing the portal site using the terminal device 40 and logging in the shared service. Specifically, a user who has already logged in the service can cause the output device 10 to output an image designated by the user when the terminal device 40 used by the user is correlated to the output device 10 by the server device 30. In the shared service, the user generally logs in by inputting a user ID and a password. In the shared service of related art, it is necessary to log the terminal device 40 into the shared service, and then, further log the output device 10 into the shared service. There is a problem that a user spends time and effort therefor. According to the information system 1 of the embodiment, the time and effort can be reduced. As below, the information processing device 20 and the server device 30 that play a central role in the information system 1 will be mainly described.

FIG. 2 shows a configuration example of the server device 30. As shown in FIG. 2, the server device 30 includes a processing device 310, a communication device 320, and a storage device 250.

The processing device 310 includes one or more processors. The processing device 310 is, for example, a CPU (central processing unit). The processing device 310 operates according to a program PRA stored in the storage device 350 and functions as a control center of the server device 30. The communication device 320 is a device that performs wireless communication or wired communication with other devices and includes, for example, interface circuit. Specific examples of other devices that communicate with the communication device 320 include the terminal device 40 and the information processing device 20.

The storage device 350 is a storage medium readable by the processing device 310. The storage device 350 includes, for example, a nonvolatile memory and a volatile memory. The nonvolatile memory is, for example, a ROM (Read Only Memory), an EPROM (Erasable Programmable Read Only Memory), or an EEPROM (Electrically Erasable Programmable Read Only Memory). The volatile memory is, for example, a RAM (Random Access Memory). The nonvolatile memory of the storage device 350 stores various programs and a management table TBL.

FIG. 3 shows an example of the management table TBL. The management table TBL stores data for correlating the user of the terminal device 40 to the output device 10. More specifically, as shown in FIG. 3, in the management table TBL, the device ID uniquely indicating the output device 10 and a first password (for example, a random sequence) for correlating a user to the output device 10 are stored in association with each other. When a certain user is correlated to the output device 10, the management table TBL stores a user ID that is identification information uniquely indicating the user and is used when logging in the shared service in association with the device ID and the first password. The user ID is identification information for uniquely identifying a user in the shared service.

Examples of the various programs stored in the nonvolatile memory include a kernel program and a program PRB. In FIG. 2, illustration of the kernel program is omitted. When the power of the server device 30 is turned on, the processing device 310 reads the kernel program from the nonvolatile memory to the volatile memory and starts execution of the read kernel program. The processing device 310 operating according to the kernel program starts execution of another program when an instruction to start execution of the other program is given. For example, when an instruction to start execution of the program PRB is given, the processing device 310 reads the program PRB from the nonvolatile memory to the volatile memory and starts execution of the program PRB read to the volatile memory.

The processing device 310 operating according to the program PRB functions as a first manager 311, a first transmitter 312, a second manager 313, and a second transmitter 314 illustrated in FIG. 2. That is, each of the first manager 311, the first transmitter 312, the second manager 313, and the second transmitter 314 illustrated in FIG. 2 is a software module realized by operation of the processing device 310 according to the program PRB. The respective roles of the first manager 311, the first transmitter 312, the second manager 313, and the second transmitter 314 illustrated in FIG. 2 are as follows.

The first manager 311 generates the first password when receiving the device ID of the output device 10 from the information processing device 20 via the network NW. The first manager 311 correlates the generated first password to the device ID received via the network NW. Specifically, the first manager 311 writes the first password and the device ID received via the network NW in the management table TBL in association with each other.

The first transmitter 312 transmits the first password to the information processing device 20 by communicating with the information processing device 20 using the communication device 320. The information processing device 20 receiving the first password causes the output device 10 to output a UI screen containing the first password. In other words, the output device 10 displays a UI screen G1 on the projection target. The UI screen G1 may be generated by the information processing device 20 or the output device 10. Transmitting the first password to the information processing device 20 by the first transmitter 312 is an example of transmitting the first password to the output device 10 by the server device 30.

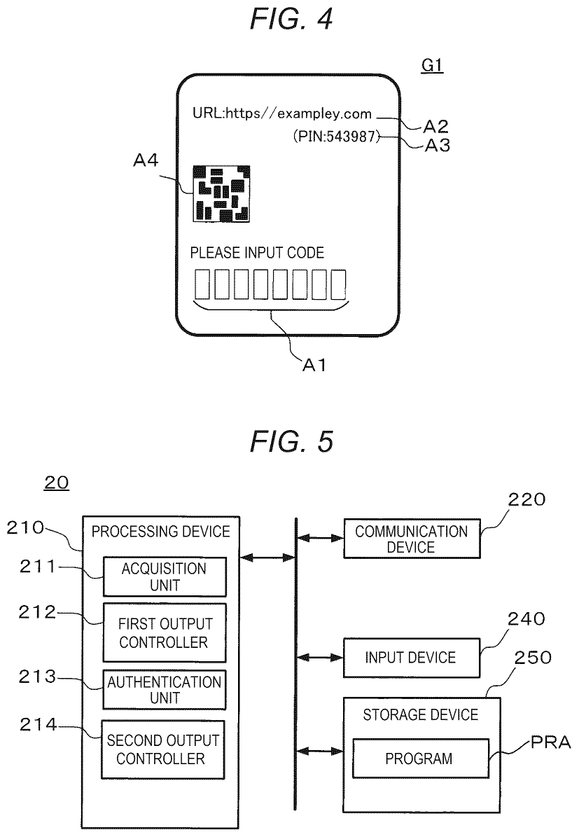

FIG. 4 shows an example of the UI screen G1 output by the output device 10. As shown in FIG. 4, the UI screen G1 includes input boxes A1 for input of a code sequence, address information A2, a PIN (Personal Identification Number) code A3 added d to the address information A2 in a format of a query character string, and a QR code A4 obtained by collective encoding of the address information A2 and the PIN code A3 in a format conforming to ISO/IEC 18004. The address information A2 is, for example, a URL of the server device 30. The PIN code A3 is an example of the first password. The QR code is a registered trademark. Although details will be described later, a second password to be described later is input to the input boxes A1. The UI screen G1 is an example of information including the first password. In the UI screen G1, any one of the address information A2, the PIN code A3, and the QR code A4 may be omitted.

The user of the terminal device 40 causes the terminal device 40 to read the QR code A4 contained in the UI screen G1 output by the output device 10 using the camera of the terminal device 40. The terminal device 40 decodes the QR code A4 to acquire the address information A2 and the first password. The address information A2 and the first password acquired by decoding of the QR code A4 are stored in the above described web storage mechanism. The user of the terminal device 40 accesses the portal site indicated by the address information A2 using the web browser, and logs in the shared service using the user ID of the user and a password determined by the user. The terminal device 40 transmits the first password acquired by decoding the QR code A4 to the server device 30 together with the user ID of the terminal device. The user ID is an example of user identification information in the present disclosure.

The second manager 313 correlates the user ID to the device ID stored in the management table TBL in association with the first password when receiving the user ID and the first password of the terminal device 40 from the terminal device 40 that has already logged in to the shared service. Specifically, the second manager 313 writes the user ID in the management table TBL in association with the first password and the device ID. Hereinafter, associating the user ID for uniquely identifying the user of the terminal device 40 with the device ID, in other words, correlating the user of the terminal device 40 to the output device 10 is referred to as “pairing”. There may be a plurality of users paired with the output device 10 for each output device 10, and thereby, the plurality of users can switch and use the single output device 10.

The second transmitter 314 transmits a common key for generating the second password to the terminal device 40 paired with the output device 10 by the second manager 313, and stores the common key in the management table TBL in association with the user ID of the user paired with the output device 10. The common key in the embodiment is a random hash character string. Since the hash character string is required to be unique for each pairing, the hash character string is generated in the server device 30.

When receiving the common key, the terminal device 40 generates and displays the second password based on the common key and a predetermined encryption algorithm. The encryption algorithm in the embodiment is a TOTP (Time-based One-Time Password) algorithm, but may be another encryption algorithm. It is desirable that the second password is updated in about 30 seconds from a recommendation of the TOTP standard, but the second password may be set to be updated in 60 seconds to 120 seconds because of the feature of sharing the projector. The user of the terminal device 40 inputs the second password displayed on the terminal device 40 by an operation on the information processing device 20. This input is not performed through a network, and not affected by wiretapping due to MitM (Man in the middle). Although the TOTP sequence is disposable and effective against wiretapping, there is a concern of a brute-force attack in the input through the network, and it is desirable to employ a direct input such as input by an operation on the information processing device 20 for the input of the second password to the information processing device 20. The brute-force attack is an attack that increases the success probability of authentication by trying a lot of different input in a short time. Since the direct input to a physical device is required to be performed at the installation location of the physical device, it is expected that the direct input to the physical device has a significant effect of discouraging an unauthorized use of the physical device as compared with the input through the network. Accordingly, in the embodiment, direct input is employed for the input of the second password to the information processing device 20.

The information processing device 20 performs authentication of the input second password by communicating with the server device 30. Specifically, the information processing device 20 transmits the input second password to the server device 30. When a password is generated based on one of the common keys stored in the management table TBL and the encryption algorithm used by the information processing device 20, the server device 30 authenticates the second password based on whether the received second password is reproduced. That is, when the second password is reproduced based on the one of the common keys stored in the management table TBL and the encryption algorithm, the authentication is successful, and when the second password is not reproduced, the authentication is unsuccessful. When the authentication of the second password is successful, the information processing device 20 communicates with the server device 30 to acquire the user ID stored in the management table TBL in association with the common key used for the reproduction of the second password, and causes the output device 10 to execute output corresponding to the user ID, that is, output of an image designated using the user ID.

The configuration of the server device 30 is described as above.

FIG. 5 shows a configuration example of the information processing device 20. As shown in FIG. 5, the information processing device 20 includes a processing device 210, a communication device 220, an input device 240, and a storage device 250. Similarly to the processing device 310, the processing device 210 includes one or more processors. Specifically, the processing device 210 is a CPU (Central Processing Unit). The processing device 210 operates according to the program PRA stored in the storage device 250 and functions as a control center of the information processing device 20. The communication device 220 includes an interface circuit similarly to the communication device 320, and performs wireless communication or wired communication with another device. Specific examples of other devices that communicate with the communication device 220 include a circuit board provided in the output device 10 and the server device 30.

The input device 240 provides data representing the details of the user's operation to the processing device 210. In the embodiment, the input device 240 is used to input the second password. In the embodiment, the input device 240 is a light receiver of a remote controller, and the second password is input by an operation on the remote controller or the like for remotely controlling the information processing device 20. The information processing device 20 does not necessarily include the input device 240. For example, the information processing device 20 may receive an operation signal of an operator provided in the output device 10 or an operation signal received via a light receiver of a remote controller provided outside the information processing device 20 in the output device 10 and input of the second password via the communication device 220. Receiving the input of the second password by the information processing device 20 is an example of receiving the input of the second password by the output device 10.

The storage device 250 is a storage medium readable by the processing device 210. Similarly to the storage device 350, the storage device 250 includes a nonvolatile memory and a volatile memory. The nonvolatile memory is, for example, a ROM (Read Only Memory), an EPROM (Erasable Programmable Read Only Memory), or an EEPROM (Electrically Erasable Programmable Read Only Memory). The volatile memory is, for example, a RAM (Random Access Memory). The nonvolatile memory of the storage device 250 stores various programs.

Examples of the various programs stored in the nonvolatile memory include a kernel program, a web browser, and a program PRA. In FIG. 5, illustration of the kernel program and the web browser is omitted. The kernel program is a program for causing the processing device 210 to implement the OS. When the power of the output device 10 is turned on, the processing device 210 reads the kernel program from the nonvolatile memory to the volatile memory and starts execution of the read kernel program. The processing device 210 operating according to the kernel program starts execution of another program when an instruction to start execution of the other program is given. For example, when an instruction to start execution of the program PRA is given, the processing device 210 reads the program PRA from the nonvolatile memory to the volatile memory and starts execution of the program PRA read to the volatile memory.

The processing device 210 operating according to the program PRA functions as an acquisition unit 211, a first output controller 212, an authentication unit 213, and a second output controller 214 shown in FIG. 5. That is, each of the acquisition unit 211, the first output controller 212, the authentication unit 213, and the second output controller 214 illustrated in FIG. 5 is a software module realized by operation of the processing device 210 according to the program PRA. The respective roles of the acquisition unit 211, the first output controller 212, the authentication unit 213, and the second output controller 214 illustrated in FIG. 5 are as follows.

The acquisition unit 211 transmits the device ID of the output device 10 to the server device 30 using the communication device 220, and acquires the first password returned from the server device 30. The first output controller 212 causes the output device 10 to output the UI screen G1 containing the first password acquired by the acquisition unit 211. The authentication unit 213 receives the input of the second password and transmits the second password input to the input boxes A1 to the server device 30, and thereby, authenticates the second password. When the authentication of the second password is successful, the second output controller 214 communicates with the server device 30 to acquire the user ID stored in the management table TBL in association with the common key used for the reproduction of the second password, and causes the output device 10 to execute output corresponding to the user ID, that is, output of an image designated using the user ID.

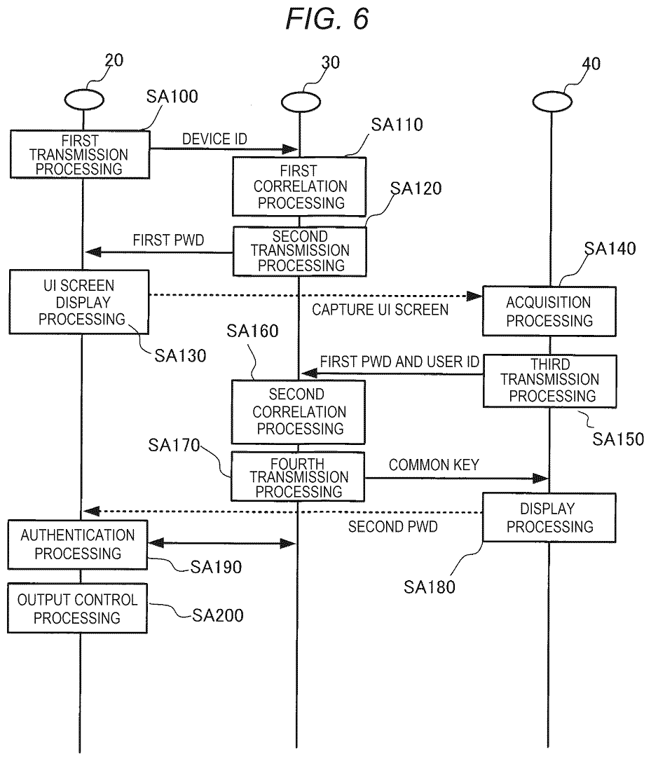

Next, the operation of the embodiment will be described with reference to FIG. 6. FIG. 6 shows a flow of processing in the information processing method executed in the information system 1. As shown in FIG. 6, the information processing method includes respective processing from first processing SA100 to output control processing SA200. The main device for execution and details of processing of each processing from the first transmission processing SA100 to the output control processing SA200 are as follows. For example, the information processing device 20 executes the first transmission processing SA100 when the power of the output device 10 is turned on. In the first transmission processing SA100, the processing device 210 of the information processing device 20 functions as the acquisition unit 211. In the first transmission processing SA100, the processing device 210 acquires the device ID of the output device 10 and transmits the acquired device ID to the server device 30.

The processing device 310 of the server device 30 executes first correlation processing SA110 when receiving the device ID via the network NW. In the first correlation processing SA110, the processing device 310 functions as the first manager 311. In the first correlation processing SA110, the processing device 310 generates the above described first password and stores the first password and the received device ID in association with each other in the management table TBL, and thereby, correlates the first password to the device ID.

In second transmission processing SA120 subsequent to the first correlation processing SA110, the processing device 310 functions as the first transmitter 312. In the second transmission processing SA120, the processing device 310 transmits the first password to the information processing device 20. In FIG. 6, the first password is abbreviated as “first PWD”.

When receiving the first password, the information processing device 20 executes UI screen display processing SA130. In the UI screen display processing SA130, the information processing device 20 functions as the above described first output controller 212, and causes the output device 10 to output the UI screen G1.

The user of the terminal device 40 instructs the terminal device 40 to read the QR code A4 contained in the UI screen G1 output by the output device 10 using the camera of the terminal device 40, and the terminal device 40 executes acquisition processing SA140 when the instruction is input. In the acquisition processing SA140, the terminal device 40 acquires the address information A2 and the PIN code A3 as the first password by decoding the QR code A4 contained in the captured image of the camera. Then, the terminal device 40 uses the web browser to access the access destination indicated by the address information A2, that is, the portal site of the shared service, and prompts the user to log in the shared service. The terminal device 40 determines whether the user have a history of a previous access to the portal site based on whether the user ID is stored in the web storage and, at a first access, redirects the screen of the portal site and asks the user to log in using the user ID of the individual user. When the login of the shared service is completed, the terminal device 40 executes third transmission processing SA150.

In the third transmission processing SA150, the terminal device 40 transmits the first password acquired in the acquisition processing SA140 and the user ID of the terminal device 40 to the server device 30. The processing device 310 of the server device 30 executes second correlation processing SA160 when receiving the first password and the user ID.

In the second correlation processing SA160, the processing device 310 functions as the second manager 313. In the second correlation processing SA160, the processing device 310 correlates the received user ID to the device ID stored in the management table TBL in association with the received first password.

In fourth transmission processing SA170 subsequent to the second correlation processing SA160, the processing device 310 functions as the second transmitter 314. In the fourth transmission processing SA170, the processing device 310 transmits a common key for generating the second password to the terminal device 40 paired with the output device 10, and stores the common key in the management table TBL in association with the user ID of the user paired with the output device 10.

The terminal device 40 executes display processing SA180 when receiving the common key. In the display processing SA180, the terminal device 40 receives the common key transmitted from the server device 30 via the network NW, generates the second password based on the common key and a predetermined encryption algorithm, and displays the generated second password. The user of the terminal device 40 can input the second password displayed on the terminal device 40 to the information processing device 20.

The processing device 210 of the information processing device 20 executes authentication processing SA190 when the second password is input to the input boxes A1 by the input operation on the input device 240. In the authentication processing SA190, the processing device 210 functions as the authentication unit 213, and authenticates the second password by transmitting the input second password to the server device 30.

In the output control processing SA200 subsequent to the authentication processing SA190, the processing device 210 functions as the second output controller 214. In the output control processing SA200, when the authentication of the second password is successful, the processing device 210 communicates with the server device 30 to acquire the user ID stored in the management table TBL in association with the common key used for reproduction of the second password, and causes the output device 10 to execute output corresponding to the user ID, that is, output of an image designated using the user ID. Outputting the designated image by the output device 10 using the user ID is an example of executing processing based on the user identification information by the output device 10.

According to the embodiment, the user inputs the user ID and the password for logging in the shared service to the terminal device 40 at hand. On the other hand, the second password input to the UI screen G1 of the output device 10 is a disposable password generated at each time. Since the login password is not input to the output device 10, the login password is not leaked even when the UI screen G1 is seen by others. Accordingly, the information system 1 can switch the user of the output device 10 while ensuring security even in the public eye.

Further, according to the embodiment, the user can share the output device 10 only by logging in the shared service and inputting the second password to the information processing device 20, and it is not necessary to log the output device 10 in to the shared service. Therefore, compared to a case where the terminal device 40 and the output device 10 are respectively logged in to the shared service, time and effort for using the shared service can be reduced in the output device 10. When there is a problem that, during class in a school or the like, the degree of attention of a student becomes lower due to the length of time taken for settings for logging the output device 10 in to the shared service, an effect that the time required for the settings or the like can be reduced and lowering of the degree of attention of the student can be avoided is achieved.

In addition, in the embodiment, the so-called zero-trust configuration in which the terminal device 40, the information processing device 20, the output device 10, and the server device 30 as physical devices respectively have data and keys in a distributed manner is employed. Accordingly, for example, even when the server device 30 is hacked or the terminal device 40 is lost, it may be impossible for a person having no means for physically accessing the output device 10 to acquire information. Similarly, even when the second password displayed by the terminal device 40 is stolen, the second password is disposable and has no effect. The communication between the server device 30 and the terminal device 40 and the communication between the server device 30 and the information processing device 20 are communications according to HTTPS with end-to-end encryption and have an advantage that interception of the communication path is difficult.

Further, in the embodiment, the UI screen G1 serving as guidance for pairing is projected on a projection screen or the like by the output device 10, and a plurality of users can simultaneously view the UI screen G1. Therefore, in the embodiment, regardless of the number of users who share the output device 10, the single UI screen G1 can be employed, and all the users can perform pairing at once using a single QR code. In a mechanism in which QR codes are individually issued to users, there is a problem that fifty types of QR codes are required when there are fifty users who share the output device 10 and the sizes of the respective fifty QR codes displayed in the UI screen are smaller, however, the problem does not occur in the embodiment. In addition, for user registration with an application, the server device 30 requires a storage for application management on the OS for each registration, and thus requires a large amount of OS resources, however, in the embodiment, the resources on the OS are required only when the PIN code is actually input and it is only necessary to secure the resources for the users who actually use the server and efficient OS management can be performed.

### 2. Other Embodiments

(1) In the above described embodiment, the service provided by the server device 30 is a shared service that allows a plurality of users to share the output device 10, however, the service may be processing of restoring information on the use environment of the output device 10 set for the output device 10 with respect to each user. The processing of restoring the information on the use environment may be, for example, switching of the user management mechanism of the OS or switching of the user storage of a specific application. Further, the service provided by the server device 30 may be a service that supports maintenance work to address a failure or the like of the output device 10 by periodically referring to information on an operation or a state of the output device 10 from a remote location (hereinafter, referred to as a maintenance support service). In other words, the processing executed by the output device 10 based on the user ID may be displaying information, changing settings of the output device 10, transmitting information to the server device 30, or the like based on the user ID in the processing. When the service provided by the server device 30 is the maintenance support service, the user of the terminal device 40 is an engineer resident in a call center or the like different from the installation location of the output device 10, and receives an inquiry from the user of the output device 10 through a telephone, an e-mail, an SMS (Short Message Service), or the like.

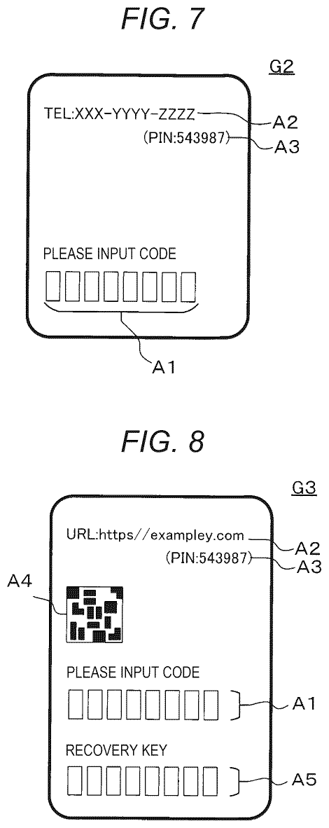

For example, when some problem occurs in the output device 10, the output device 10 outputs a support screen by operation of the output device 10. The operation for outputting the support screen is preferably as simple as possible, and is preferably, for example, an operation of a predetermined button provided in advance on the main screen. FIG. 7 shows an example of a support screen G2. The support screen G2 includes input boxes A1 for input of a code sequence, a PIN code A3, and address information A2 for access to the call center. The address information A2 in the embodiment is a telephone number of a support desk in the call center, and an inquiry is made by a telephone. The PIN code A3 is preferably a number of about 6 to 9 digits, and a number of about 6 to 9 digits can preferably be input to the input boxes A1.

More specifically, the output device 10 registers its own device ID in the server device 30 via the information processing device 20 prior to the output of the support screen G2 when the predetermined button is operated. When receiving the device ID, the server device 30 issues a PIN code as a random sequence for each output device 10 required to be remotely operated, and stores the device ID and the PIN code in the management table TBL in association with each other. The PIN code corresponds to the first password in the above described embodiment. Then, the server device 30 returns the PIN code issued in association with the device ID to the output device 10, and the output device 10 outputs the support screen G2 containing the PIN code.

The user of the output device 10 makes an inquiry to the call center by telephone with reference to the address information A2 contained in the support screen G2. A maintenance staff member at the call center inquires about the PIN code displayed on the support screen G2, and transmits the PIN code heard from the user of the output device 10 to the server device 30 together with one of the plurality of maintenance IDs assigned to the call center in advance, using the terminal device 40 used by the staff. The maintenance ID corresponds to the user ID in the above described embodiment. When the PIN code received from the terminal device 40 is stored in the management table TBL, the server device 30 adds the maintenance ID received together with the PIN code to the management table TBL in association with the device ID of the output device 10. Thus, pairing between the terminal device 40 of the maintenance staff member and the output device 10 requiring support is realized. After the pairing, the server device 30 transmits the common key to the terminal device 40 used by the maintenance staff member paired with the output device 10 requiring support.

The terminal device 40 generates a second password based on the common key received from the server device 30 and a predetermined encryption algorithm, and displays the generated second password. The maintenance staff member informs the user of the output device 10 of the second password displayed on the terminal device 40 and prompts the user to input the second password into the input boxes A1. When the user inputs the second password, the output device 10 communicates with the server device 30 to authenticate the second password. When the second password is successfully authenticated, the output device 10 transmits log information as information on the operation or the state of the output device to the server device 30 together with the second password. The server device 30 stores the log information in a predetermined storage area in the storage device 250, and permits only the user indicated by the maintenance ID corresponding to the common key used for generation of the second password received together with the log information to refer to the storage area. The maintenance staff member of the output device 10 accesses the storage area using the terminal device 40 to conduct an analysis of a problem occurring in the output device 10 or the like. Only the maintenance staff member of the output device 10 is permitted to access the storage area, and thereby, an access to the log information by a third party can be prevented.

According to the configuration, the log information of the output device 10 at a remote location can be collected by simple exchange of two types of numerical sequences, and an effect that problems of the user unskilled in the operation of the device can be easily recognized is achieved. In the configuration, the zero-trust configuration using the disposable sequence is employed, and thereby, a spot survey can be performed on the user of the output device 10 without concern for remote control for the indefinite future and an effect of enhancing the sense of security is achieved. Further, in the configuration, since the main processing can be performed by the server device 30, it is not necessary to construct a large system at the output device 10 side, and a lightweight embedded OS or an inexpensive OS can be used as the OS of the output device 10. Furthermore, according to the configuration, incident information indicating details, an occurrence frequency, and the like of a problem may be in the server device 30 together with the maintenance ID, the device ID, and the log information. The above described management is performed, and thereby, the occurrence history of problems in the past of individual users can be quickly recognized with respect to each output device 10 and, when the problem reoccurs, operational management can be continuously performed using the same maintenance ID.

(2) In the above described embodiment, the authentication of the second password is performed in the server device 30. However, the server device 30 may transmit the common key generated in association with the user ID to the information processing device 20, and the information processing device 20 may authenticate the second password. In this case, the information processing device 20 authenticates the second password based on whether the password generated based on the common key and the above described encryption algorithm, and the second password input to the input boxes A1 of the UI screen G1 match. That is, when the generated password matches the second password, the authentication is successful, and when the generated password does not match the second password, the authentication is unsuccessful. When the authentication is successful, the information processing device 20 transmits the common key that can reproduce the second password to the server device 30. The server device 30 acquires the user ID correlated to the common key received from the information processing device 20 from the management table TBL.

### 3. Modifications

The above described embodiments may be modified as below.

(1) The output device 10 in the above described embodiments is a projector, however, the present disclosure may be applied to shared use of equipment necessary for a plurality of persons to switch the operation in the public eye, for example, a large-screen television or audio, or an IoT (Internet of Things) device having confidentiality and operated on a public occasion. As an example, when a key for private lodging is provided to a user, the configuration of the present disclosure may be used in order to solve a problem that a key number for a touch panel-type key is peeped.

(2) The processing device 310 may store a recovery key in the management table TBL in correlation to the user ID of the user who has completed login to the shared service and the common key, and may transmit the recovery key to the terminal device 40. The recovery key is a random sequence like the first password. When a new terminal device different from the terminal device 40 logs in the shared service using the user ID, the processing device 310 may request input of the recovery key, and when receiving the recovery key, may transmit the common key correlated to the recovery key to the new terminal device. The new terminal device different from the terminal device 40 is an example of a second terminal device. In the configuration using the recovery key, as shown in FIG. 8, using a UI screen G3 provided with input boxes A5 for input of the recovery key instead of the UI screen G1 is considered. According to the configuration, the user records the recovery key transmitted from the server device 30, for example, in a note or the like, and thereby, for example, even in a case where the terminal device 40 is lost or the like, when logging in to the shared service using the new terminal device, the server device 30 can confirm the login by the authenticated user using the recovery key. Accordingly, the information system 1 can provide the service based on the user ID registered in the management table TBL to the user using the new terminal device while ensuring security.

(3) The acquisition unit 211, the first output controller 212, the authentication unit 213, and the second output controller 214 in the above described embodiments are software modules. However, one, two, three, or all of the acquisition unit 211, the first output controller 212, the authentication unit 213, and the second output controller 214 may be hardware modules such as ASICs (application specific integrated circuits). Even when at least one of the acquisition unit 211, the first output controller 212, the authentication unit 213, and the second output controller 214 is a hardware module, the same effects as those of the above described embodiments are achieved. Similarly, at least one of the first manager 311, the first transmitter 312, the second manager 313, and the second transmitter 314 may be a hardware module.

(4) The program PRA may be manufactured alone and may be provided with or without compensation. Specific configurations for providing the program PRA include a configuration for writing and providing the program PRA in a computer-readable storage medium such as a flash ROM and a configuration for downloading and providing the program PRA through an electrical communication line such as the Internet. A general computer is operated according to the program PRA provided by these configurations, and thereby, the computer can be caused to execute the display method of the present disclosure. Similarly, the program PRB may be manufactured alone, or may be provided with or without compensation.

### 4. Summary of Present Disclosure

The present disclosure is not limited to the above described embodiments and modification examples, but can be implemented in various configurations without departing from the spirit and scope of the present disclosure. For example, the present disclosure can also be implemented by the following configurations. Technical features in the above described embodiments corresponding to technical features in the respective configurations described below can be replaced or combined as appropriate, in order to solve part or all of the problems of the present disclosure or in order to achieve part or all of the effects of the present disclosure. Further, the technical features can be deleted as appropriate, unless described as essential features in the specification.

As below, the summary of the present disclosure will be appended.

### Appendix 1

An information processing method of the present disclosure includes correlating device identification information indicating an output device to a first password by a server device that provides a service via a network, transmitting the first password to the output device by the server device, outputting information containing the first password by the output device, transmitting the first password to the server device by a first terminal device that has already logged in to the service using user identification information, correlating the user identification information to the device identification information based on the first password by the server device, transmitting a common key correlated to the user identification information to the first terminal device by the server device, displaying a second password based on the common key and an encryption algorithm by the first terminal device, receiving input of the second password by the output device, acquiring the user identification information corresponding to the common key from the server device based on the second password and the encryption algorithm by the output device, and executing processing based on the user identification information by the output device. According to the configuration, the user can link the user to the output device via the network by two simple input operations including input of the user identification information for logging in to the service and input of the second password to the output device. As compared with a case where the output device is further logged in to the service after the terminal device is logged in to the service, the time and effort of the user can be reduced.

### Appendix 2

The information processing method having a more preferable configuration is the information processing method according to Appendix 1, the information containing the first password includes address information of a website that provides the service, and the method further includes accessing the website using the address information by the first terminal device, and logging in to the service from the website using the user identification information by the first terminal device. According to the configuration, the user can access a website that provides a predetermined service using the address information contained in the information output from the output device.

### Appendix 3

The information processing method having a more preferable configuration is the information processing method according to Appendix 2, further including, when login to the service by the first terminal device is completed, storing a recovery key in correlation to the user identification information and the common key by the server device, transmitting the recovery key to the first terminal device by the server device, when a second terminal device different from the first terminal device logs in to the service using the user identification information, requesting input of the recovery key by the server device, and when receiving the recovery key from the second terminal device, transmitting the common key correlated to the recovery key to the second terminal device by the server device. According to the configuration, when the user uses the second terminal device in place of the first terminal device or in addition to the first terminal device, the user can easily recover the link between the user and the output device via the network.

### Appendix 4

The information processing method having another preferable configuration is the information processing method according to any one of Appendixes 1 to 3, further including transmitting the common key to the output device by the server device, and performing authentication of the second password based on the common key and the encryption algorithm by the output device, wherein acquiring the user identification information from the server device by the output device includes acquiring the user identification information when the authentication is successful. According to the configuration, the authentication of the user linked to the output device via the network can be executed in the output device.

### Appendix 5

In the information processing method having another preferable configuration is the information processing method according to any one of Appendixes 1 to 4, the encryption algorithm is a Time-based One-Time Password algorithm. According to the configuration, the authentication of the user linked to the output device via the network can be executed using the second password generated using the Time-based One-Time Password algorithm.

### Appendix 6

In the information processing method having another preferable configuration is the information processing method according to any one of Appendixes 1 to 5, the output device is an image display device that displays an image, and the processing based on the user identification information is displaying an image corresponding to the user identification information. According to the configuration, an image corresponding to a user can be displayed on an output device linked to the user via a network.

### Appendix 7

In the information processing method having another preferable configuration is the information processing method according to any one of Appendixes 1 to 5, the processing based on the user identification information is transmitting information on an operation or a state of the output device to the server device. According to the configuration, information on the operation or the state of the output device linked to the user is transmitted to the server device via the network, and the user can refer to the information by accessing the server device.

### Appendix 8

A server device of the present disclosure includes a communication device that communicates with each of an output device and a first terminal device, and at least one processor, wherein the at least one processor executes providing a service via a network, correlating device identification information indicating the output device to a first password, transmitting the first password to the output device using the communication device, receiving the first password using the communication device from the first terminal device that has already logged in to the service using user identification information, correlating the user identification information to the device identification information based on the first password, transmitting a common key associated with the user identification information to the first terminal device using the communication device to cause the first terminal device to output a second password based on the common key and a predetermined encryption algorithm, performing authentication of the second password based on the encryption algorithm, and transmitting the user identification information corresponding to the common key to the output device when the authentication is successful. According to the configuration, the user can link the user to the output device via the network by two simple input operations including input of the user identification information for logging in to the service and input of the second password to the output device. As compared with a case where the output device is further logged in to the service after the terminal device is logged in to the service, the time and effort of the user can be reduced.

### Appendix 9

An information processing device of the present disclosure includes a communication device that communicates with each circuit board of a server device providing a service and an output device, and at least one processor, wherein the at least one processor executes transmitting device identification information indicating the output device to the server device using the communication device, acquiring a first password for correlating the device identification information to user identification information indicating a user that has logged in to the service from the server device, causing the output device to output information containing the first password, receiving a common key associated with the user identification information in the server device from the server device, receiving input of a second password based on the common key and an encryption algorithm, performing authentication of the second password based on the common key and the encryption algorithm, acquiring the user identification information corresponding to the common key from the server device when the authentication is successful, and causing the output device to execute processing based on the user identification information. According to the configuration, the user can link the user to the output device via the network by two simple input operations including input of the user identification information for logging in to the service and input of the second password to the output device. As compared with a case where the output device is further logged in to the service after the terminal device is logged in to the service, the time and effort of the user can be reduced.

What is claimed is:

1. An information processing method comprising:
correlating device identification information indicating an output device to a first password by a server device that provides a service via a network;
transmitting the first password to the output device by the server device;
outputting information containing the first password by the output device;
transmitting the first password to the server device by a first terminal device that has already logged in to the service using user identification information;
correlating the user identification information to the device identification information based on the first password by the server device;
transmitting a common key correlated to the user identification information to the first terminal device by the server device;
displaying a second password based on the common key and an encryption algorithm by the first terminal device;
receiving input of the second password by the output device;
acquiring the user identification information corresponding to the common key from the server device based on the second password and the encryption algorithm by the output device; and
executing processing based on the user identification information by the output device.

2. The information processing method according to claim 1, wherein
the information containing the first password includes address information of a website that provides the service,
the method further comprising:
accessing the website using the address information by the first terminal device; and
logging in to the service from the website using the user identification information by the first terminal device.

3. The information processing method according to claim 2, further comprising:
when login to the service by the first terminal device is completed, storing a recovery key in correlation to the user identification information and the common key by the server device;
transmitting the recovery key to the first terminal device by the server device;
when a second terminal device different from the first terminal device logs in to the service using the user identification information, requesting input of the recovery key by the server device; and
when receiving the recovery key from the second terminal device, transmitting the common key correlated to the recovery key to the second terminal device by the server device.

4. The information processing method according to claim 1, further comprising:
transmitting the common key to the output device by the server device; and
performing authentication of the second password based on the common key and the encryption algorithm by the output device, wherein
acquiring the user identification information from the server device by the output device includes acquiring the user identification information when the authentication is successful.

5. The information processing method according to claim 1, wherein
the encryption algorithm is a Time-based One-Time Password algorithm.

6. The information processing method according to claim 1, wherein
the output device is an image display device that displays an image, and
the processing based on the user identification information is displaying an image corresponding to the user identification information.

7. The information processing method according to claim 1, wherein
the processing based on the user identification information is transmitting information on an operation or a state of the output device to the server device.

8. A server device comprising:
a communication device that communicates with each of an output device and a first terminal device; and
at least one processor programmed to execute
providing a service via a network,
correlating device identification information indicating the output device to a first password,
transmitting the first password to the output device using the communication device,
receiving the first password using the communication device from the first terminal device that has already logged in to the service using user identification information,
correlating the user identification information to the device identification information based on the first password,
transmitting a common key associated with the user identification information to the first terminal device using the communication device to cause the first terminal device to output a second password based on the common key and a predetermined encryption algorithm,
performing authentication of the second password based on the encryption algorithm, and
transmitting the user identification information corresponding to the common key to the output device when the authentication is successful.

9. An information processing device comprising:
a communication device that communicates with each circuit board of a server device providing a service and an output device; and
at least one processor programmed to execute
transmitting device identification information indicating the output device to the server device using the communication device,
acquiring a first password for correlating the device identification information to user identification information indicating a user that has logged in to the service from the server device,
causing the output device to output information containing the first password,
receiving a common key associated with the user identification information in the server device from the server device,
receiving input of a second password based on the common key and an encryption algorithm,
performing authentication of the second password based on the common key and the encryption algorithm,
acquiring the user identification information corresponding to the common key from the server device when the authentication is successful, and
causing the output device to execute processing based on the user identification information.
